(19) United States
(12) Patent Application Publication
(10) Pub. No.: US 2013/0267031 A1
(43) Pub. Date: Oct. 10, 2013

(54) Method for Measuring Neuropeptide Y in Biological Samples

(71) Applicant: NATIONAL MEDICAL SERVICES, INC., Kennett Square, PA (US)

(72) Inventor: Robert Middleberg, Willow Grove, PA (US)

(73) Assignee: NATIONAL MEDICAL SERVICES, INC., Kennett Square, PA (US)

(21) Appl. No.: 13/826,308

(22) Filed: Mar. 14, 2013

Related U.S. Application Data
(60) Provisional application No. 61/611,048, filed on Mar. 15, 2012.

(51) Int. Cl. G01N 27/62

(52) U.S. Cl. CPC G01N 27/62
USPC 436/86

(57) ABSTRACT

The present invention provides methods for determining the amount of NPY in a biological sample using mass spectrometry. The methods involve specific sample collection processes necessary to stabilize and facilitate NYP analyses. Once in the laboratory, sample preparation is followed by on-line extraction, liquid chromatographic separation of relevant moieties with detection by MS/MS whereby specific ion transitions are monitored. This invention has several clinical utilities related to disease processes and patient assessment.

### CROSS REFERENCE TO RELATED APPLICATIONS

This application is a non-provisional application, the entire contents of which is incorporated by reference herein and claims priority, in part, of U.S. Provisional Application No. 61/611,048, filed on Mar. 15, 2012.

### BACKGROUND

1. Field of Invention

The present invention relates to the methods for detecting compounds that are classified as neuropeptide Y and related metabolites by mass spectrometry.

2. Description of Related Art

Neuropeptide Y (NPY) is one of the most abundant peptides in the brain. It is responsible for inducing a variety of behavioral effects such as stimulation of food intake, anxiety, facilitation of learning memory, and regulation of the cardiovascular and neuroendocrine systems. In the periphery, NPY stimulates vascular smooth muscle contraction and modulates hormone secretion. NPY has been implicated in hypertension, congestive heart failure, and appetite regulation.

NPY is a 36 amino acid peptide neurotransmitter found in the brain and autonomic nervous system. It is secreted by the hypothalamus. The metabolism of NPY is believed to occur at its N-terminus by two proline-preferring aminopeptidases, aminopeptidase P and dipeptidyl peptidase IV.

Clinically dependable techniques to detect different NPY forms have been poorly developed. There is little information on how NPY proteolysis by peptidases occurs in serum, in part because reliable techniques are lacking to distinguish the different NPY forms and also because factors affecting the expression of these enzymes are not well understood. In one study, LC-MS/MS was used to identify and quantify NPY fragments resulting from peptidolytic cleavage of NPY1-36 upon incubation with human serum (Abid et al., Kinetic Study of Neuropeptide Y (NPY) Proteolysis in Blood and Identification of NPY3-35, J. Bio. Chem., 284; 24715-24724 (2009)). Kinetic studies indicated that NPY1-36 is rapidly cleaved in serum into 3 main fragments with the following order of efficacy: NPY3-36>>NPY3-35>NPY2-36. Trace amounts of additional NPY forms were identified by accurate mass spectrometry. NPY3-35 may represent the major metabolic clearance product of the Y2/Y5 agonist, NPY3-36. LC-MS/MS is used to identify and quantify NPY fragments resulting from peptidolytic cleavage of NPY₁₋₃₆ upon incubation with human serum.

With reports of numerous effects in both the central and peripheral nervous systems, measuring levels in a biological sample of NPY and its metabolites has become a clinically important objective in the prognosis and diagnosis of associated diseases and their influence on NPY receptor subtypes.

Accordingly, there exists a need to assess NPY and its metabolites using fast and highly accurate mass spectrometry-based processes which may better detect and resolve NPY and the metabolites. The present invention provides a simple high-throughput liquid chromatography-tandem mass spectrometry (LC-MS/MS) process for measuring NPY and its metabolites.

### SUMMARY

The instant invention provides a method for detecting NPY in a biological sample by mass spectrometry, including tandem mass spectrometry. Depending on the metabolite to be detected, the analysis provides information useful to the clinician in the diagnosis of diseases associated with stress and eating disorders and potentially other types where NPY has been implicated.

One aspect of the present invention provides methods for detecting by mass spectrometry the presence or amount of a neuropeptide Y metabolite in a sample. In one embodiment, methods are provided for determining, by mass spectrometry, the presence or amount of one or more NPY metabolites, that include: (a) isolating NPY in the test sample by sample preparation processes and liquid chromatography; (b) ionizing NPY and related compounds in the test sample; and (c) detecting the amount of NPY and related compounds via ions(s) produced by mass spectrometry and relating the amount of the detected NPY ion(s) to the amount of NPY in the test sample. In one embodiment, the limit of detection and quantitation of the method is less than or equal to “pg/ml”; and preferably, NPY is not derivatized prior to mass spectrometry. In other embodiments, the methods include generating one or more precursor ions of NPY in which at least one of the precursor ions has a unique mass/charge ratio. Other embodiments may include generating one or more fragment ions of NPY precursor and/or metabolite in which at least one of the fragment ions has a unique mass/charge ratio. In certain other embodiments, the test sample is a body fluid. The methods may include ultracentrifugation of the test sample, and/or isolation with chemical solvents and solutions and/or through solid-phase or on-line extraction (SPE).

In a preferred embodiment, methods are provided for determining the amount of NPY in a body fluid sample by tandem mass spectrometry that include: (a) purifying NPY in the body fluid sample by on-line extraction via liquid chromatography; (b) generating precursor ions of the multiply-charged species of NPY 1-36 and NPY 3-36 having a mass/charge ratio of 713.3 and 669.6, respectively; (c) generating one or more fragment ions of the precursor ion in which the fragment ions have mass/charge ratios of 751.1 and 695.4 for NPY 1-36; and 751.1 and 797.8 for NYP 3-36; and (d) detecting the amount of one or more of the ions generated in step (b) or (c) both and relating the detected ions to the amount of NPY in the body fluid sample. In one embodiment, the limit of quantitation of the methods is less than or equal to 0.3 ng/mL for both NPY 1-36 and NPY 3-36. In another embodiment, NPY is not derivatized prior to mass spectrometry.

In some embodiments of the above methods, NPY may be derivatized prior to mass spectrometry, however, in certain preferred embodiments, sample preparation excludes the use of derivatization.

In certain embodiments of the invention, liquid chromatography is performed using HPLC, preferably on-line extraction is used in conjunction with developed chromatographic separation, however other methods can be used that include for example, protein precipitation and purification in conjunction with HPLC.

In certain embodiments of the methods disclosed herein, mass spectrometry is performed in positive ion mode. Alternatively, mass spectrometry is performed in negative ion mode. Other embodiments measure NPY using both positive and negative ion mode. In certain embodiments, NPY is measured using either APCI or ESI in either positive or negative mode.

In a preferred embodiment, the NPY ions detectable in a mass spectrometer are selected from the group consisting of ions with a mass/charge ratio (m/z) of 713.3 and 669.6.

In a preferred embodiment, separately detectable internal NPY standards are added to the sample, the amount of which is also determined in the sample. The internal standards used include deuterated analogs of NPY 1-36 and NPY 3-36, thus constituting isotope dilution mass spectrometry. In these embodiments, all or a portion of both the endogenous NPY and the internal standard present in the sample are ionized to produce a plurality of ions detectable in a mass spectrometer, and one or more ions produced from each are detected by mass spectrometry.

Preferred NPY internal standards are NPY 1-36-D8 and NYP 3-36-D8. In the preferred embodiments, the internal NPY standard ions detectable in a mass spectrometer are selected from the group consisting of ions with a mass/charge ratio of 714.3, 752.1 and 696.4 for NPY 1-36-D8; and 671, 753.4 and 799.8 for NPY 3-36-D8.

In the preferred embodiments, the presence or amount of NPY 1-36 and NPY 3-36 is related to the presence or amount of the corresponding NPY in the test sample by comparison to internal standard and responses of calibrators consisting of NPY 1-36, NPY 3-36, NPY 1-36-D8 and NPY 3-36D-8.

In one embodiment, the methods involve the combination of liquid chromatography with mass spectrometry. In a preferred embodiment, the liquid chromatography is HPLC. A preferred embodiment utilized HPLC alone or in combination with one or more purification methods such as protein purification or on-line extraction to purify and isolate NPY in samples. In another embodiment, the mass spectrometry is tandem mass spectrometry (MS/MS).

In one preferred embodiment, the limit of quantitation (LOQ) of NPY is less than or equal to 0.3 ng/ml; preferably less than or equal to 0.1 ng/mL.

In summary, the invention described above is non-limiting and other features and advantages of the invention will be apparent from the following detailed description of the invention, and from the claims.

### BRIEF DESCRIPTION OF THE FIGURES

FIG. 1 is a diagram showing a process for performing mass spectrometric analysis.

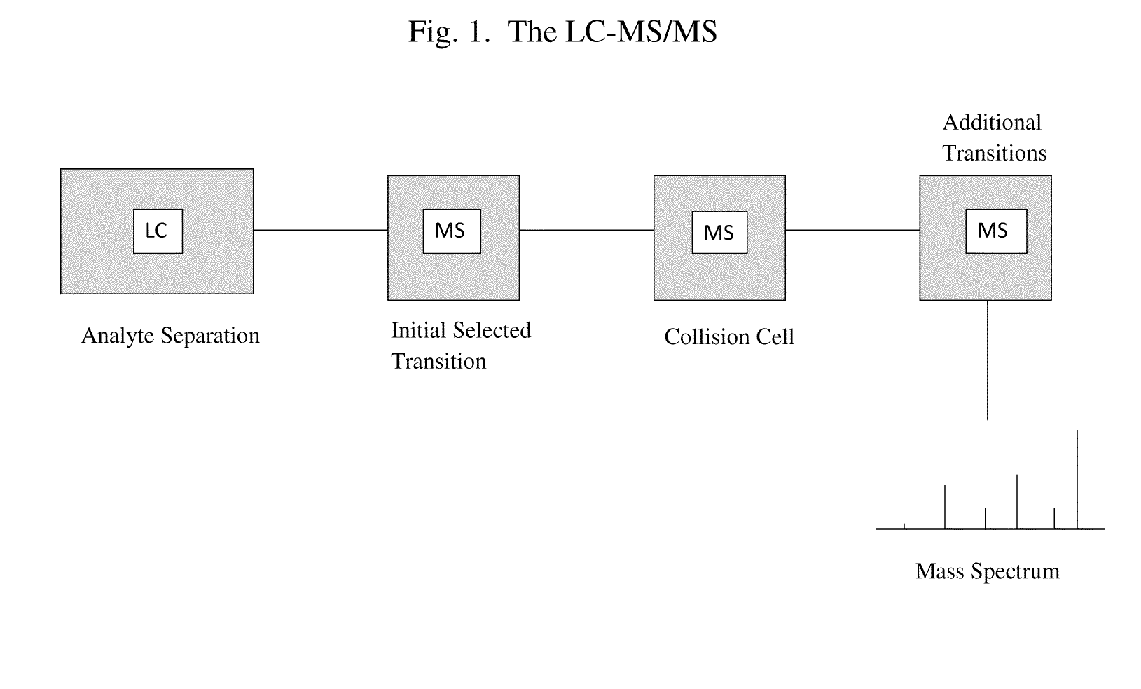

FIG. 2 depicts a chromatogram of NPY 1-36 and NPY 3-36

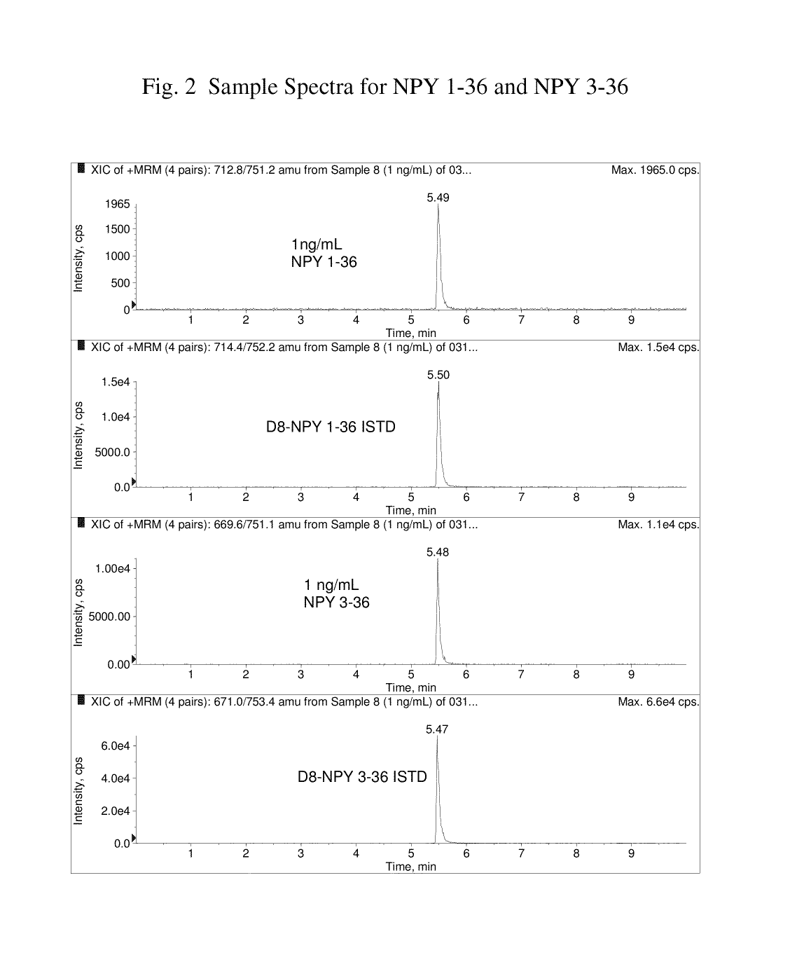

FIG. 3 is a schematic of NYP analysis of a serum sample.

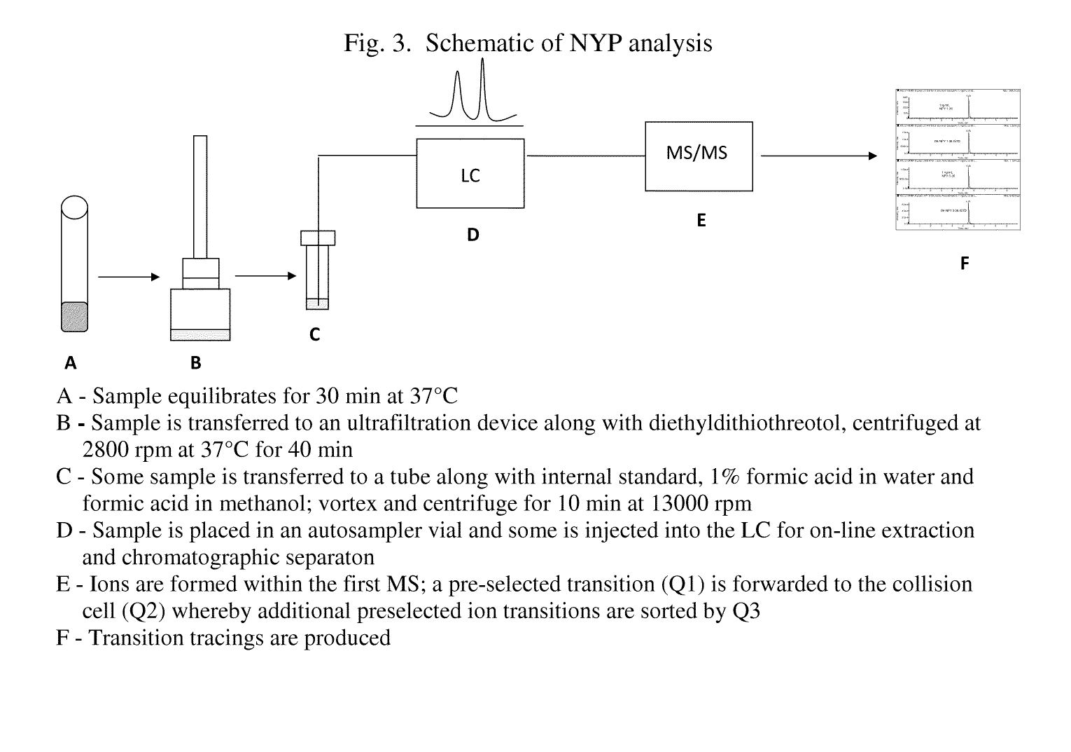

### DETAILED DESCRIPTION OF INVENTION

Methods are described using mass spectrometry for detecting and quantifying Neuropeptide Y 1-36 and 3-36 (NPY 1-36 and NPY 3-36) in a test sample. Certain aspects of the invention involve isolating the compounds of interest, ionizing the compounds of interest, detecting the ion(s) by mass spectrometry, and relating the presence or amount of the ion(s) and the presence or amount of related NPY metabolites(s) in the sample. Certain embodiments are particularly well suited for application in large clinical laboratories. Methods of detecting and quantifying NPY are provided that have enhanced specificity and/or are accomplished in less time and with less sample preparation than required in other NPY metabolite assays.

### Definitions

An NPY metabolite refers to any NPY species that is present in the circulation of an individual or animal, formed through a biosynthetic or metabolic pathway or a synthetic NPY analog. In certain embodiments the NPY metabolites are naturally present in a body fluid of a mammal (such as a human).

A biological sample refers to any sample from a biological source. Body fluid means any fluid that can be isolated from the body of an individual. For example but not limited to, body fluid may include, blood, plasma, serum, bile, saliva, urine, tears, perspiration, and the like.

Chromatography refers to a process in which a chemical mixture carried by a liquid or gas is separated into components as a result of differential distribution of the chemical entities between a stationary liquid or solid phase and a flowing liquid or gas.

Liquid chromatography (LC) means a process of selectively retarding one or more components of a fluid solution as the fluid uniformly percolates through a column of a finely divided substance, or through capillary passageways. The retardation results from the distribution of the components of the mixture between one or more stationary phases and the bulk fluid, (i.e. mobile phase), relative to the stationary phase and the related chemical processes, thereof. Liquid chromatography includes reverse phase liquid chromatography (RPLC), normal phase chromatography and a host of other chemistries to facilitate a separation process. Certain forms of liquid chromatography are carried out using HPLC.

High performance liquid chromatography (HPLC) refers to liquid chromatography in which the degree of separation is increased by forcing the mobile phase under pressure through a stationary phase, typically a densely packed column.

Mass spectrometry (MS) refers to an analytical technique to identify compounds by their mass to charge ratio, MS technology generally includes four components: (1) sample introduction, e.g. HPLC; (2) ionizing the compounds to form charged compounds; (3) separation of the produced ions; and (4) detecting the charged species by monitoring mass to charge ratios. The compound may be ionized and then detected by any suitable means. See U.S. Pat. No. 6,204,500 “Mass Spectrometry From Surfaces”; U.S. Pat. No. 6,107,623 “Methods and Apparatus for Tandem Mass Spectrometry”; U.S. Pat. No. 6,268,144 “DNA diagnostics Based on Mass Spectrometry” U.S. Pat. No. 6,124,137 “Surface-Enhanced Photolabile Attachment and Release for Desorption and Detection of Analytes”, Wright et al “Prostate Cancer and Prostate Diseases 2:264-276 (1999); and Merchan and Weinberger, Electrophoresis 21:1164-1167 (2000), all incorporated by reference.

Ionization refers to the process of generating an analyte ion having a net electrical charge equal to one or more electron units. Negative ions are those having a net negative charge of one or more electron units, while positive ions are those having a net positive charge of one or more electron units.

Operating in negative ion mode refers to those mass spectrometry methods where negative ions are detected. Similarly, operating in positive ion mode refers to those mass spectrometry methods where positive ions are detected.

### Test Samples

Suitable test samples include any test sample that may contain the analyte of interest. For example, samples obtained during the manufacture of an analyte can be analyzed to determine the composition and yield of the manufacturing process; that is, a sample obtained from any biological source, such as an animal, a cell culture, an organ culture, etc. In certain embodiments, samples are obtained from a mammalian animal, such as a dog, cat, horse, etc. Exemplary mammalian animals are primates, most preferably humans. Exemplary samples include blood, plasma, serum, hair, muscle, urine, saliva, tear, cerebrospinal fluid, or other tissue samples. Such samples may be obtained, for example, from a patient; that is, a living person presenting oneself in a clinical setting for diagnosis, prognosis, or treatment of a disease or condition. The test sample may be obtained from a patient, for example, blood serum. Samples may also be harvested from deceased individuals.

### Sample Preparation for Mass Spectrometry

Methods may be used prior to mass spectrometry to enrich NPY, its metabolites or related compounds relative to other components in the sample, or to increase the concentration of NPY, its metabolites or related compounds in the sample. Such methods include, for example, filtration centrifugation, thin layer chromatography, electrophoresis including capillary electrophoresis, affinity separations including immunoaffinity separations and extraction methods, both pre-analytical and on-line or any combination of the above or the like.

Samples may be processed or purified to obtain preparations that are suitable for analysis by mass spectrometry. Such purification will usually include chromatography, such as liquid chromatography, and may also often involve an additional purification procedure that is performed prior to chromatography. Various procedures may be used for this purpose depending on the type of sample or the type of chromatography. Examples include filtration, extraction, precipitation, centrifugation, delipidization , dilution, combinations thereof and the like

### Liquid Chromatography

Generally, chromatography may be performed prior to mass spectrometry; the chromatography may be liquid chromatography, such as high performance liquid chromatography.

Liquid chromatography including high-performance liquid chromatography rely on relatively slow, laminar flow technology. Traditional HPLC analysis relies on column packing in which laminar flow of the sample and mobile phase through the column is the basis for separation of the analyte of interest form the sample. The skilled artisan will understand that separation in such columns is a diffusional process. HPLC has been successfully applied to the separation of compounds in biological samples. But a significant amount of sample preparation is required prior to the separation and subsequent analysis with a mass spectrometer, making this technique labor intensive. In addition, most HPLC systems do not utilize the mass spectrometer to its fullest potential, allowing only one HPLC system to be connected to a single MS instrument, resulting in lengthy time requirements for performing a large number a of assays.

Various methods have been described involving the use of HPLC for sample clean-up prior to mass spectrometric analysis (see e.g. Taylor et al, Therapeutic Drug Monitoring 22:608-612 (2000) (manual precipitation of blood samples, followed by manual C18 solid phase extraction, injection into an HPLC for chromatography on a C18 analytical column and MS/MS analysis); and Salm et al Clin. Therapeutics 22 Supp B:B71-B85 (200) (manual precipitation of blood samples followed by manual C18 solid phase extraction and then injection into an HPLC for chromatography on a C18 analytical column, and MS/MS analysis).

One skill in the art is selecting HPLC instruments and columns that are suitable for use in the invention. The chromatographic column typically includes a medium (i.e. a packing material) to facilitate separation of chemical moieties (i.e. fractionation). The medium may include minute particles. The particles include a bonded surface that interacts with the various chemical moieties to facilitate separation of the chemical moieties. One suitable bonded surface is a hydrophobic bonded surface such as an alkyl bonded surface. Alkyl bonded surfaces may include C-4, C-8, or C-18 bonded alkyl groups, often times, but not isolated to, C-18 bonded groups. The chromatographic column includes an inlet port for receiving a sample and an outlet port for discharging an effluent that includes the fractionated sample. In one embodiment, the sample (or pre-purified sample) is applied to the column at the inlet port, eluted with a solvent or solvent mixture, and discharged at the outlet port. Different solvent modes, or mobile phases, may be selected for eluting the analytes of interest. For example, liquid chromatography may be performed using a gradient mode, an isocratic mode, or a polytyptic (mixed) mode. During chromatography, the separation of material is affected by variables such as choice of column, eluent (mobile phase), choice of gradient elution and the gradient conditions, temperature, etc.

In certain embodiments, an analyte may be purified by applying a sample to a column under conditions where the analyte of interest is reversibly retained by the column packing material while one or more other materials are not retained. In these embodiments, a first mobile phase condition can be employed where the analyte of interest is retained by the column and a second mobile phase condition can subsequently be employed to remove retained material from the column, once the non-retained materials are washed through. Alternatively, an analyte may be purified by applying a sample to a column under mobile phase conditions where the analyte of interest elutes at a differential rate in comparison to one or more other materials. Such procedures may enrich the amount of one or more analytes of interest relative to one or more other components of the samples.

### Detection and Quantification by Mass Spectrometry

The present invention discloses mass spectrometric methods for detecting the presence or amount of one or more NPY moieties or related compounds in a sample. In certain aspects, the method involves on-line extraction of NPY moieties and related compounds, ionizing the compounds, detecting the ion(s) by mass spectrometry, and relating the presence or amount of the ion(s) to the presence or amount of NPY moieties and related compounds in the sample.

Mass spectrometry may be performed using a mass spectrometer which includes an ion source for ionizing the fractionated sample and creating charged molecules for further analysis. For example, ionization of the sample may be performed by electrospray ionization, atmospheric pressure chemical ionization, atmospheric pressure photoionization, photoionization, electron ionization, fast atom bombardment/liquid secondary ionization, matrix assisted laser desorption ionization, field ionization , field desorption, thermospray/plasmaspray ionization, and particle beam ionization. The skilled artisan will understand that the choice of ionization method can be determined based on the analyte to be measure, type of sample, the type of detector , the choice of positive versus negative mode, etc.

After the sample has been ionized, the positively charged or negatively charged ions thereby created may be analyzed to determine a mass-to-charge ratio (i.e. m/z). Suitable analyzers for determining mass-to-charge ratios include, but are not limited to, quadrupole analyzers, ion trap analyzers, and time-of-flight analyzers. The ions may be detected using several detection modes. For example, selected ions may be detected (e.g. using a selective ion monitoring mode (SIM), or alternatively, ions may be detected using a scanning mode e.g. multiple reaction monitoring (MRM) or selected reaction monitoring (SRM). The mass-to-charge ratio is determined using a quadrupole, or other, analyzer. For example, in a quadrupole or quadrupole ion trap instrument, ions in an oscillating radio frequency field experience a force proportional to the DC potential applied between electrodes, the amplitude of the RF signal, and m/z. The voltage and amplitude can be selected so that only ions having a particular m/z travel the length of the quadrupole, while all other ions are deflected. Thus, quadrupole instruments can act as both a mass filter and as a mass detector for the ions injected into the instrument.

One may enhance the resolution of the MS technique by employing tandem mass spectrometry or MS/MS. In this technique, a precursor ion (also called a parent ion) generated from a molecule of interest can be filtered in an MS instrument and the precursor ion is subsequently fragmented to yield one or more fragments ions (also called daughter ions or product ions) that are then analyzed in a second MS procedure. By careful selection of precursor ions, only ions produced by certain analytes are passed to the fragmentation chamber, where collision with atoms of an inert gas produce the daughter ions. Because both the precursor and fragment ions are produced in a reproducible fashion under a given set of ionization/fragmentation conditions, the MS/MS technique can provide an extremely powerful analytical tool. For example, the use of tandem mass spectrometry (MS/MS) can be used to eliminate interfering substances, and can be particularly useful in complex samples, such as biological samples.

The mass spectrometer typically provides the user with an ion scan; that is, the relative abundance of each ion with a particular m/z over a given range (e.g. 100 to 200 amu). The results of an analyte assay, that is, a mass spectrum, can be related to the amount of the analyte in the original sample by numerous methods known in the art. For example, standards (a.k.a. calibrators) can be run with the samples, and a standard curve constructed based on ions generated from those standards. Using such a standard curve, the relative abundance of a given ion can be converted into an absolute amount of the molecule present in the sample. In certain embodiments, an internal standard is used as a reference compound to facilitate generation of a standard curve for calculating the quantity of the NPY moieties and related compounds. Methods of generating and using such standard curves are well known in the art and one of ordinary skill is capable of selecting an appropriate internal standard. For example, an isotope of NPY 1-36 may be used as an internal standard, in some embodiments, the NPY moiety or related compound is a deuterated NPY moiety or related compound. Numerous other methods for relating the presence or amount of an ion to the presence or amount of the original molecule will be well known to those of ordinary skill in the art.

One or more steps of the methods of the invention can be performed using automated machines. In certain embodiments, one or more purification steps are performed on-line, and more preferably all of the purification and mass spectrometry steps may be performed in an on-line fashion.

In certain embodiments such as MS/MS where precursor ions are isolated for further fragmentation, collision activation dissociation (CAD) is often used to generate the fragment ions for further detection, In CAD, precursor ions gain energy through collisions with an inert gas, and subsequently fragment by processes, including but not limited to, unimolecular decomposition. Sufficient energy must be deposited in the precursor ion so that certain bonds within the ion can be broken due to, but not limited to, increased vibrational energy.

In certain embodiments, NPY moieties or related compounds are detected and quantified using LC-MS/MS as follows. The samples are subjected to liquid chromatography, preferably HPLC, the flow of liquid solvent from the chromatographic column enters the heated nebulizer interface of a LC-MS/MS analyzer and the solvent/analyte mixture is converted to vapor in the heated tubing of the interface. The analytes (NPY moieties) contained in the nebulized solvent are ionized through a series of processes involving drying gases, charge application, etc. The pre-selected ions, i.e. precursor ions, pass through the orifice of the instrument and enter the first quadrupole. Quadrupoles 1 and 3 (Q1 and Q3) are mass filters, allowing selection of ions (i.e. precursor and fragment ions) based on the mass to charge ratio (M/Z). Quadrupole 2 (Q2) is the collision cell where precursor ions are fragmented. The first quadrupole of the mass spectrometer (Q1) selects molecules with the mass to charge ratios of the specific NPY moieties to be analyzed. Precursor ions with the correct m/z ratios of the precursor ions of the specific NPY moiety are allowed to pass into the collision chamber (Q2) while unwanted ions with any other m/z collide with the sides of the quadrupole and are eliminated or pumped away. Precursor ions entering Q2 collide with neutral Argon gass molecules and fragment. This process is called Collision Activated Dissociation (CAD). The fragment ions generated are passed into quadrupole 3 (Q3) where the fragment ions of the desired NPY moiety are selected while other ions are eliminated.

The methods of the invention may involve MS/MS performed in either positive or negative ion mode. Using standard methods well known in the art, one of ordinary skill is capable of identifying one or more fragment ions of a particular precursor ion of an NPY metabolite that can be used for selection in quadrupole 3 (Q3).

In one embodiment, ions collide with the detector and produce a pulse of electrons that are converted to a digital signal. Other detector physics/engineering can be used, e.g., time of flight. The acquired data is relayed to a computer which plots counts of the ions collected versus time. The resulting mass spectra are similar by analogy to chromatograms generated in traditional HPLC methods. The areas under the peaks corresponding to particular ions, or the amplitude of such peaks are measured and the area or amplitude is correlated to the amount of the analyte (NPY moiety) of interest. In certain embodiments, the area under the curves, or amplitude of the peaks, for fragment ion(s) and precursor ions are measured to determine the amount of NPY moiety. As described above, the relative abundance of a given ion can be converted into an absolute amount of the original analyte, i.e. NPY moiety, using calibration standard curves based on peaks of one or more ions of the NPY moiety of interest and an internal standard.

In certain aspects of the invention, the quantity of various ions is determined by measuring the area under the curve or the amplitude of the peak and a ratio of the quantities of the ions is calculated and monitored (i.e. daughter ion ratio monitoring). In certain embodiments of the method, the ratio(s) of the quantity of a precursor ion and the quantity of one or more fragment ions of an NPY metabolite can be calculated and compared to the ratio(s) of a standard of the NPY moiety similarly measured. In embodiments where more than one fragment ion of an NPY metabolite is monitored, the ratio(s) for different fragment ions may be determined instead of, or in addition to, the ratio of the fragment ion(s) compared to the precursor ion. In embodiments where such ratios are monitored, if there is a substantial difference in an ion ratio in the sample as compared to the standard, it is likely that a molecule in the sample is interfering with the results or some other analytical phenomenon is in practice. To the contrary, if the ion ratios in the sample and the molecular standard are similar, then there is increased confidence that there is no interference. Accordingly, monitoring such ratios in the samples and comparing the ratios to those of authentic standards may be used to increase the accuracy of the method.

In certain embodiments of the invention, the presence or absence of an amount of two or more NPY moieties in a sample might be detected in a single assay using the above described MS/MS methods.

### Selected Methods

One aspect of the invention related to a method for assessing the amount of an NPY moiety in a sample comprising the steps of: (a) isolating the moiety of interest with pre-analytical or on-line processes (b) injecting extracted sample into an HPLC (c) mass spectrometric analysis, thereby generating a plurality of ions; and (c) detecting and quantifying one or more ions.

In certain embodiments, the present invention relates to any one of the aforementioned methods wherein said sample comprises a biological fluid.

In certain embodiments, the present invention relates to any one of the aforementioned method further comprising the step of assaying the amount of NPY metabolite in the sample.

In certain embodiments, the present invention relates to any one of the aforementioned methods wherein the NPY moiety is present in the first sample at a concentration either at, above or below the limit of quantitation.

In certain embodiments, the present invention relates to any one of the aforementioned methods wherein the NPY moiety is NPY 1-36 or NPY 3-36 or related compounds.

In certain embodiments, the present invention relates to any one of the aforementioned methods wherein the mass spectrometer is a Quadrupole, Time-of-Flight (Q-TOF) mass spectrometer, Ion Trap Time-of-Flight (IT-TOF) mass spectrometer, Time-of-Flight (TOF) mass spectrometer or a triple QUAD mass spectrometer (tandem mass spectrometer).

In certain embodiments, the present invention relates to any one of the aforementioned methods wherein the ions are precursor ions and subsequently formed ions.

In certain embodiments, the present invention relates to any one of the aforementioned methods wherein at least one of said ions has a mass/charge ratio as described in this application.

### Clinical Relevance

Neuropeptide Y is a 36 amino acid peptide very similar throughout all species of mammals. It is found primarily in the sympathetic nervous system, gut, and brain. Neuropeptide Y is closely related structurally to Peptide YY and Vasoactive Intestinal Polypeptide. Neuropeptide Y has key roles in cardiovascular and hypothalamic function. It potentiates vasoconstriction, causing an increase in blood pressure. Levels are increased by stress, dexamethasone, septic shock, relaxation of the colon, Atrial Natriuretic Factor (ANF), water and sodium secretion, Luteinizing Hormone (LH) and Adrenocorticotropin hormone (ACTH). Levels are inhibited by amphetamines, and are decreased in patients with Alzheimer's disease. Neuropeptide Y inhibits norepinephrine, the effect of cholecystokinin, renin release, insulin and glucagon secretion, and the melanotropins. Actions of Neuropeptide Y are enhanced by α-2 adrenoreceptor agonists.

Neuropeptide Y 3-36 is a potent angiogenic peptide. Endothelium contains not only NPY receptors but also peptide itself, its mRNA, and the “NPY-converting enzympe” dipeptidyl peptidase IV (both protein and mRNA), which terminates the Y1 activity of NPY and cleaves the Tyr1-Pro2 from NPY to form an angiogenic Y2 agonist, NPY3-36. Endothelium is thus not only the site of action of NPY but also the origin of the autocrine NPY system, which, together with the sympathetic nerves, may be important in angiogenesis during tissue development and repair.

### Selected Kits

This invention also provides specimen collection kits for conveniently and effectively measuring the amount of NPY 1-36, NPY 3-36 and potential related products in a biological sample. In certain embodiments, the kit contains specific test tubes containing specific chemicals to stabilize and facilitate NPY analyses.

A kit of invention may include instructions in any form that are provided in connection with the methods of the invention in such a manner that one of ordinary skill in the art would recognize said instructions and realize they are associated with the methods of the invention.

This invention requires the collection and storage of specimens in pre-defined tubes and temperatures. Such directions are associated with the proper testing of samples for NPY moieties.

I claim:

1. A method for simultaneously determining the amount of neuropeptide Y and its metabolites in a test sample comprising:
a. isolating neuropeptide Y and its metabolites in a test sample using liquid chromatography;
b. ionizing neuropeptide Y and its metabolites in the test sample;
c. detecting the amount ions(s) produced by mass spectrometry; and
d. correlating the amount of the detected ion(s) to the amount of neuropeptide Y and its metabolites in the test sample.

2. The method of claim 1 wherein isolating neuropeptide Y and its metabolites includes ultracentrifugation.

3. The method of claim 1 wherein isolating neuropeptide Y and its metabolites includes solid-phase extraction.

4. The method of claim 1 wherein liquid chromatography is HPLC.

5. The method of claim 4 further includes protein purification or on-line extraction.

6. The method of claim 1 wherein neuropeptide Y and its metabolites are derivatized prior to step (c).

7. The method of claim 1 wherein at least one of the ions of neuropeptide Y or its metabolites has a unique mass/charge ratio.

8. The method of claim 1 wherein step (c) further comprises generating at least one fragment ion of neuropeptide Y or its metabolites having a unique mass/charge ratio.

9. The method of claim 1 wherein mass spectrometry is tandem mass spectrometry.

10. The method of claim 9 wherein tandem mass spectrometry is performed in positive ion mode, negative ion mode, or a combination of positive and negative ion mode.

11. The method of claim 1 wherein the amount of neuropeptide Y and its metabolites in the test sample are less than or equal to picograms per milliliter.

12. The method of claim 1 wherein the test sample is a body fluid.

13. A high throughput method for determining the amount of neuropeptide Y in a body fluid sample comprising:
a. obtaining a body fluid sample;
b. purifying neuropeptide Y from the sample by on-line extraction using liquid chromatography;
c. generating precursor ions of NPY 1-36 and NPY 3-36 having a mass/charge ration of 713.3 and 669.6 respectively;
d. detecting at least one fragment ion from the precursor ions having a mass/charge ratio of 751.1 or 695.4 for NPY 1-36 and 751.1 or 797.8 for NPY 3-36 respectively by mass spectrometry; and
e. correlating the amount of the detected ions in step (b) and (c) to the amount of neuropeptide Y in the body fluid sample.

14. The method of claim 13 wherein the amount of neuropeptide Y in the body fluid is at least 0.3 nanograms per milliliter for NPY 1-36 and NPY 3-36.

15. The method of claim 13 wherein liquid chromatography is HPLC.

16. The method of claim 15 further includes protein purification or on-line extraction.

17. The method of claim 13 wherein neuropeptide Y is derivatized prior to mass spectroscopy.

18. The method of claim 13 wherein an internal neuropeptide Y standard is added to the sample in a detectable amount.

19. The method of claim 18 wherein the internal standards are deuterated analogs of NPY 1-36 and NPY 3-36.

20. The method of claim 19 wherein the deuterated analogs are NPY 1-36-D8 and NPY 3-36-D8 having a mass/charge ratio of 714.3, 752.1 and 696.4 for NYP 1-36-D8 and 671, 753.4 and 799.8 for NPY 3-36-D8 respectively.

21. A method for detecting disorders in an individual comprising:
a. obtaining a biological sample from an individual;
b. isolating neuropeptide Y and its metabolites in the sample by a sample preparation process;
c. ionizing neuropeptide Y and its metabolites in the sample;
d. detecting the amount ions(s) produced by mass spectrometry and relating the amount of the detected ion(s) to the amount of neuropeptide Y and its metabolites in the sample; and
e. comparing the amount neuropeptide Y and its metabolites in the sample with amounts indicative of disease.

22. The method of claim 21 wherein the amount of neuropeptide Y increases due to a disorder from the group consisting of stress, septic shock, elevated levels of dexamethasone, elevated levels of atrial natriuretic factor, elevated levels of water and sodium secretion, elevated levels of lutenizing hormone, and elevated levels of adrenocorticoropin hormone.

23. The method of claim 21 wherein the amount of neuropeptide Y decreases due to Alzheimer's disease or elevated levels of amphetamine.
